(19) United States
(12) Patent Application Publication
(10) Pub. No.: US 2021/0373347 A1
(43) Pub. Date: Dec. 2, 2021

(54) LASER HEAD CAPABLE OF DYNAMICALLY REGULATING LASER SPOT BY HIGH FREQUENCY/ULTRAHIGH FREQUENCY MICRO-VIBRATION

(71) Applicant: Huazhong University of Science and Technology, Wuhan (CN)

(72) Inventors: Xiuquan MA, Wuhan (CN); Tianyu XU, Wuhan (CN); Gaoyang MI, Wuhan (CN); Shaowei ZHOU, Wuhan (CN); Xinyu SHAO, Wuhan (CN)

(73) Assignee: Huazhong University of Science and Technology, Wuhan (CN)

(21) Appl. No.: 17/126,183

(22) Filed: Dec. 18, 2020

(30) Foreign Application Priority Data
Jun. 1, 2020 (CN) 202010484215.0

(51) Int. Cl. G02B 27/09; G02B 27/30; G02B 19/00; H01S 3/00; G02B 26/08; B23K 26/06; B23K 26/073; B23K 26/082

(52) U.S. Cl. CPC G02B 27/0933; G02B 27/30; G02B 19/0009; G02B 19/0047; H01S 3/067; G02B 26/0875; B23K 26/0648; B23K 26/073; B23K 26/082; H01S 3/005

(57) ABSTRACT

Disclosed is a laser head capable of dynamically regulating a laser spot by high frequency/ultrahigh frequency micro-vibration, including a laser transmitting device, a cavity, a special electromechanical module and a shielded nozzle. The laser transmitting device is disposed at the top of the cavity. A first protective glass and a collimating lens are sequentially disposed from top to bottom within the cavity. The special electromechanical module is disposed at the bottom of the cavity and connected to the cavity by means of a housing. A focusing lens is further disposed within the housing of the special electromechanical module, and a flat spring is disposed between the focusing lens and the special electromechanical module. The special electromechanical module can cause ultrahigh frequency micro-oscillation of the focusing lens. The shielded nozzle is disposed at the bottom of the special electromechanical module.

### CROSS REFERENCE TO RELATED APPLICATION

This application claims the priority of Chinese Patent Application No. 202010484215.0, filed with the China National Intellectual Property Administration on Jun. 1, 2020, which is incorporated herein by reference in its entirety.

### TECHNICAL FIELD

The present disclosure relates to the technical field of laser processing equipment, and in particular, to a laser head capable of dynamically regulating a laser spot by high frequency/ultrahigh frequency micro-vibration.

### BACKGROUND

A laser spot is a focal plane of a laser beam with a processed workpiece, which directly determines the acting position, size and energy density distribution of the laser. The dynamic regulation of a laser spot is crucial for promoting the laser processing level. It is common to add a device (e.g., a split light path, a galvanometer) to a laser head for spot regulation, which has achieved a certain effect. However, it is hard to meet high-speed and high-response regulation requirements with a traditional spot regulation strategy within a laser head in a lot of operating conditions, such as operating conditions requiring extremely high spot energy homogeneity (e.g., large-breadth cleaning) and operating conditions requiring an extremely high spot moving speed (e.g., laser stir welding).

It can be seen through analysis in principle that there are two breakthroughs for realizing high-response smart spot control. One is to reduce an original spot size and increase the beam contraction degree as much as possible under the same power condition so as to narrow a spot; and the other is to realize high-speed movement of an original spot in any direction in a two-dimensional space, thus fully improving the controllability of an output spot. The first is closely related to a laser device and will be gradually resolved with the continuous development of the laser device technology. The second is made possible only by regulating an output beam.

There are three types of existing laser spot regulating methods: direct spot magnifying, spot beam splitting, and spot sweeping.

Most direct spot magnifying methods permit direct adjustment of relative positions of lenses in a light path and can achieve spot size regulation accordingly, but may definitely lead to attenuation of the power density due to constant total power.

Spot beam splitting methods permit beam splitting with a lens to obtain a plurality of beams from one beam and thus can be well used on some specific processing occasions, but may merely achieve very limited effects because the number of spots can be changed only within a certain range.

Spot sweeping methods can allow for a vibration frequency small than or equal to 500 Hz at present and cannot achieve ultrahigh frequency (vibration frequency ranging from 1 kHz to 30 kHz) motion. Moreover, galvanometer structures are mostly employed for fulfilling vibration, which cannot stand the laser power of more than 10000 watts.

To sum up, in the current laser processing field, it is difficult to implement dynamic regulation of the spot form, especially high-response dynamic regulation.

### SUMMARY

The present disclosure aims to provide a laser head capable of dynamically regulating a laser spot by high frequency/ultrahigh frequency micro-vibration to solve the above problem in the prior art. Ultrahigh frequency micro-oscillation of a focusing lens is initiated, and when collimated laser light passes through the focusing lens, ultrahigh frequency micro-vibration may occur in the laser light along with the ultrahigh frequency micro-vibration of the focusing lens. In this case, the diameter of an output spot may vary in real time with the change of the amplitude of the focusing lens, and therefore, high-response regulation of the spot form can be realized. Thus, the requirements of operating conditions of laser cutting, laser welding, laser additive processing, etc. can be met.

To achieve the above objective, the present disclosure provides the following solutions:

The present disclosure provides a laser head capable of dynamically regulating a laser spot by high frequency/ultrahigh frequency micro-vibration, including: a laser transmitting device, a cavity, a special electromechanical module and a shielded nozzle, where the laser transmitting device is disposed at the top of the cavity to emit laser into the cavity through an entrance port formed in the top of the cavity; a first protective glass and a collimating lens are sequentially disposed from top to bottom within the cavity; the special electromechanical module is disposed at the bottom of the cavity and connected to the cavity by means of a housing; light holes are formed in the top and bottom of the housing of the special electromechanical module, respectively; a focusing lens is further disposed within the housing of the special electromechanical module, and a flat spring is disposed between the focusing lens and the special electromechanical module; the special electromechanical module is capable of causing ultrahigh frequency micro-oscillation of the focusing lens; and the shielded nozzle is disposed at the bottom of the special electromechanical module.

Preferably, an optical fiber end cap is disposed between the laser transmitting device and the cavity.

Preferably, the special electromechanical module is a voice coil motor; a lens holder for the focusing lens is connected to a live coil of the voice coil motor; the flat spring is connected to a housing of the voice coil motor; when a high-frequency alternating current is applied to the live coil, a magnetic field generated by the live coil interacts with a magnetic field of a permanent magnet to induce a high frequency periodic force for acting on the focusing lens, which is also simultaneously acted upon by the force of the flat spring; driven by the two forces, the focusing lens spins like a satellite at an ultrahigh frequency.

Preferably, the special electromechanical module is a vibration exciter.

Preferably, a second protective glass is further disposed at an internal bottom end of the housing of the special electromechanical module.

Preferably, the entrance port, the first protective glass, the collimating lens, the light holes, the focusing lens and the second protective glass are disposed concentrically.

Preferably, the light emitted by the laser transmitting device is a Gaussian beam having a wavelength ranging from 1030 to 1080 nm.

Preferably, the collimating lens has a diameter greater than a cross-section size of the Gaussian beam at a position where the lens is located so as to encompass the entire beam within a refraction range.

Compared with the prior art, the present disclosure achieves the following beneficial effects:

1. In the laser head capable of dynamically regulating a laser spot by high frequency/ultrahigh frequency micro-vibration provided in the present disclosure, ultrahigh frequency micro-vibration of any one of a focusing lens, a collimating lens and an optical fiber end cap is initiated. When collimated laser passes through the focusing lens, the focused laser may move along with the ultrahigh frequency micro-vibration of the focusing lens, and in this case, the equivalent spot diameter varies with the change of the amplitude of the focusing lens. As a result, the requirements for different materials and different laser processing techniques are met, and applications on high power processing occasions can be ensured. Hence, multi-occasion and multi-function laser processing can be truly realized.

2. As compared with direct spot magnifying methods, in the laser head capable of dynamically regulating a laser spot by high frequency/ultrahigh frequency micro-vibration provided in the present disclosure, a special electromechanical module is used to cause ultrahigh frequency micro-vibration of a corresponding component to realize spot size regulation, which may not lead to attenuation of the power density. As compared with spot beam splitting methods, the focusing lens, the collimating lens or the optical fiber end cap in the present disclosure may cause ultrahigh frequency micro-vibration of the spot, so that better control of a molten pool, high regulation flexibility and processing effect improvement are achieved. As compared with spot sweeping methods, the special electromechanical module used in the present disclosure has a vibration frequency ranging from 1 kHz to 30 kHz, which is higher than the frequency of an existing galvanometer motor. Accordingly, the present disclosure may be superior to a galvanometer-based laser oscillation system in processing effect and processing efficiency.

### BRIEF DESCRIPTION OF THE DRAWINGS

To describe the technical solutions in examples of the present disclosure or in the prior art more clearly, the accompanying drawings required for describing the examples will be briefly described below. Apparently, the accompanying drawings in the following description show merely some examples of the present disclosure, and a person of ordinary skill in the art may still derive other drawings from these accompanying drawings without creative efforts.

FIG. 1 is a schematic structure diagram of a laser head capable of dynamically regulating a laser spot by high frequency/ultrahigh frequency micro-vibration according to the present disclosure.

FIG. 2 is a schematic structure diagram of a voice coil motor according to the present disclosure.

FIG. 3 is a schematic diagram of oscillation motion of a focusing lens according to the present disclosure.

FIG. 4 is a distribution diagram of spots formed by focused laser in a focusing plane according to the present disclosure.

FIG. 5 is a schematic structure diagram of a flat spring according to the present disclosure.

In the drawings, what reference numerals denote are: 1-laser transmitting device, 2-incident light, 3-collimating lens, 4-collimated beam, 5-focusing lens, 6-flat spring, 7-special electromechanical module, 8-cavity, 9-first protective glass, 10-focused laser beam, 11-second protective glass, 12-shielded nozzle, 13-laser focusing plane, 14-optical fiber end cap, 15-voice coil motor housing, 16-live coil, and 17-magnet.

### DETAILED DESCRIPTION

The technical solutions in examples of the present disclosure will be described below clearly and completely with reference to the accompanying drawings in the examples of the present disclosure. Apparently, the described examples are merely a part rather than all of the examples of the present disclosure. All other examples derived from the examples in the present disclosure by a person of ordinary skill in the art without creative efforts shall fall within the protection scope of the present disclosure.

An objective of the present disclosure is to provide a laser head capable of dynamically regulating a laser spot by high frequency/ultrahigh frequency micro-vibration to solve the problems in the prior art.

To make the foregoing objective, features, and advantages of the present disclosure clearer and more comprehensible, the present disclosure will be further described in detail below with reference to the accompanying drawings and specific examples.

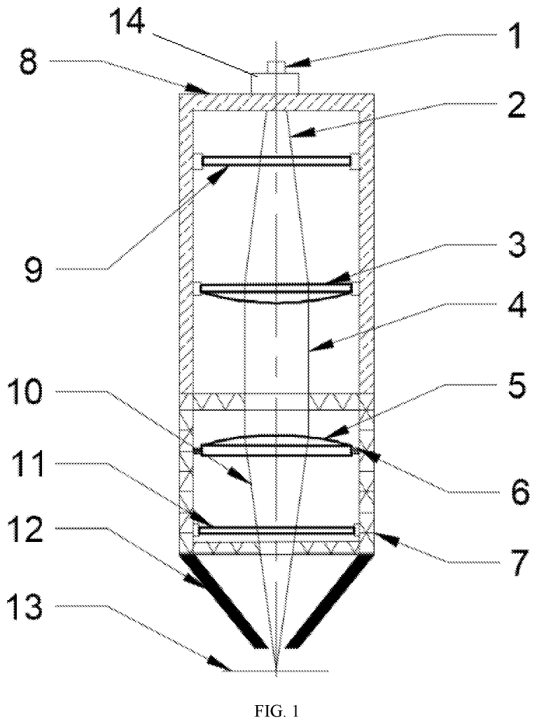

A laser head capable of dynamically regulating a laser spot by high frequency/ultrahigh frequency micro-vibration in this embodiment, as shown in FIG. 1, includes a laser transmitting device 1, a cavity 8, a special electromechanical module 7 and a shielded nozzle 12. The laser transmitting device 1 is disposed at the top of the cavity 8 to emit laser into the cavity 8 through an entrance port formed in the top of the cavity 8. A first protective glass 9 and a collimating lens 3 are sequentially disposed from top to bottom within the cavity 8. The special electromechanical module 7 is disposed at the bottom of the cavity 8 and connected to the cavity 8 by means of a housing. Light holes are formed in the top and bottom of the housing of the special electromechanical module 7, respectively. A focusing lens 5 is further disposed within the housing of the special electromechanical module 7, and a flat spring 6 is disposed between the focusing lens 5 and the special electromechanical module 7. The special electromechanical module 7 is capable of causing ultrahigh frequency micro-oscillation of the focusing lens 5. The shielded nozzle 12 is disposed at the bottom of the special electromechanical module 7.

In this embodiment, an optical fiber end cap 14 is disposed between the laser transmitting device 1 and the cavity 8. The optical fiber end cap 14, which is a high power device processed and designed with regard to output end faces of a high power fiber laser device and an amplifier, can reduce the optical power density at the output end by expanding an output beam. Moreover, with the design of a special end face angle, echo reflection by the end face is significantly reduced (better than -35 dB). The optical fiber end caps 14 can be applied to output ends of laser devices (amplifiers) having high power which can be high peak power or high average power, resulting in minimal distortion of output beams.

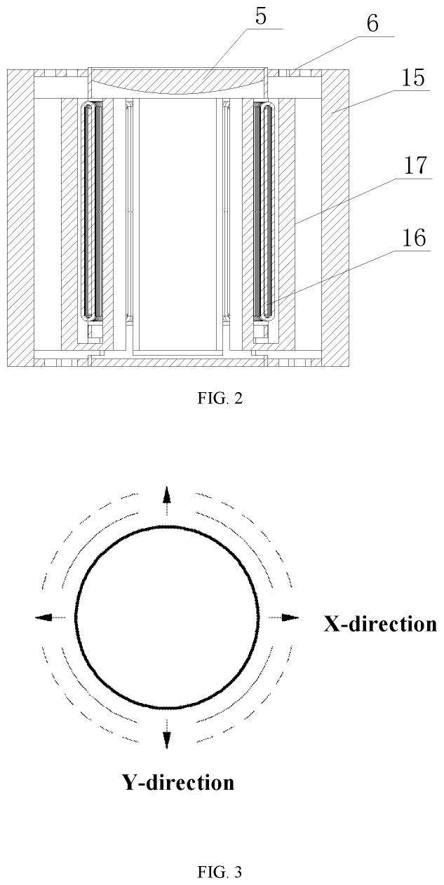

The special electromechanical module 7 in this embodiment can be chosen as a voice coil motor (as shown in FIG. 2). A lens holder for the focusing lens 5 is connected to a live coil 16 of the voice coil motor. The flat spring 6 is connected to a housing 15 of the voice coil motor. When a high-frequency alternating current is applied to the live coil 16, a magnetic field generated by the live coil 16 interacts with a magnetic field of a permanent magnet 17 to induce a high frequency periodic force for acting on the focusing lens 5, which is also simultaneously acted upon by the force of the flat spring; driven by the two forces, the focusing lens 5 spins like a satellite at an ultrahigh frequency.

The special electromechanical module 7 in this embodiment can also be chosen from a vibration exciter and other electromechanical devices that can apply a high frequency periodic acting force to other objects, serving to apply a high frequency periodic acting force to the optical fiber end cap 14, the focusing lens 5 or the collimating lens in the horizontal plane, causing the optical fiber end cap 14, the focusing lens 5 or the collimating lens to circumferentially revolve around a center at a high frequency within the horizontal plane without spinning itself.

In this embodiment, a second protective glass 11 is further disposed at the internal bottom end of the housing of the special electromechanical module. The second protective glass 11 has a particular thickness of 1-6 mm and serves to prevent contaminants such as particulate matters from entering the special electromechanical module, ensuring that the electromechanical module and the focusing lens 5 operate in a clean environment and are free from contamination.

In this embodiment, the entrance port, the first protective glass 9, the collimating lens 3, the light holes, the focusing lens 5 and the second protective glass 11 are disposed concentrically, so that the collimated laser can be exactly directed to the center of the static focusing lens 5.

In this embodiment, the laser transmitting device 1 can transmit continuous laser with particular power. The transmitted laser is a Gaussian beam having a wavelength ranging from 1030 to 1080 nm that serves as an energy source for flexible laser processing.

The collimating lens 3 has a diameter greater than a cross-section size of the Gaussian beam at a position where the lens is located so as to encompass the entire beam within a refraction range. The collimating lens 3 is capable of adjusting an incident beam to a parallel beam which basically does not diverge in the transmission process and is transmitted to the focusing lens 5 in parallel. The lens is a common high transmittance lens and can stand the laser power of at least 15000 watts.

The diameter of a collimated beam 4 depends on the NA value of an optical fiber that generates incident light 2 and a distance between a laser emitting point and the plane of the collimating lens, and may not exceed the maximum diameter of the working faces of the collimating lens and the focusing lens 5.

FIG. 3 is a schematic diagram of oscillation of the focusing lens 5. The combined action of the special electromechanical module 7 and the annular flat spring 6 causes ultrahigh frequency micro-vibration of the lens at a frequency ranging from 1 kHz to 30 kHz with an amplitude of 0 to D (e.g., D is equal, but not limited, to 500 μm) in both X-direction and Y-direction, which can be finally synthesized into circumferential movement. The oscillation form of the lens is that it revolves at an ultrahigh frequency around an axis parallel to its axis without spinning itself.

The flat spring 6, the cross section of which is as shown in FIG. 5, has an elasticity coefficient K greater than 500 N/m and can guarantee that the focusing lens 5 rebounds rapidly after moving under the action of the special electromechanical module 7, causing the oscillation frequency of the focusing lens 5 to range from 1 kHz to 30 kHz.

The first protective glass 9 has a particular thickness of 1-6 mm and serves to prevent particulate matters and the like from contact with the lenses below and protect the lenses and the cavity 8 from contamination.

A focused laser beam 10 vibrates at the same frequency with the focusing lens 5 and may finally be focused into a minimum diameter spot in the focal plane.

The shielded nozzle 12 is mounted under the special electromechanical module 7 and serves to prevent splashes generated when laser acts on a workpiece from entering the cavity 8 and the electromechanical module above, allowing for a clean environment for operation.

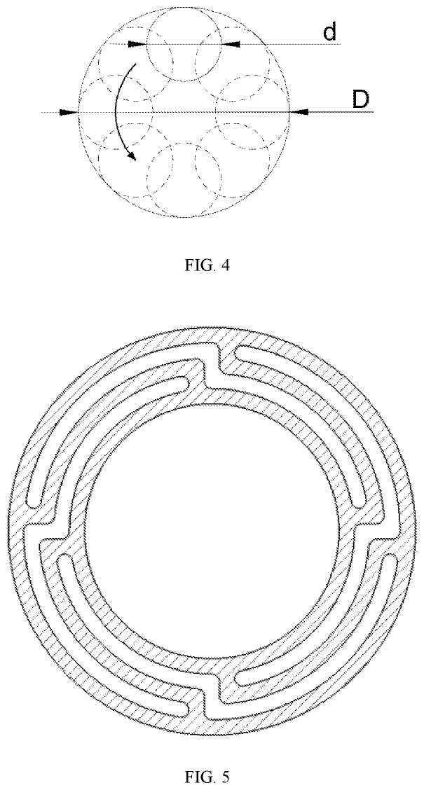

A laser focusing plane 13 has a diameter d (d ranges from 10 to 100 μm) when the spot is static. When the focusing lens 5 operates, a spot as shown in FIG. 4 may be formed by the focused laser in the plane, and in this case, the equivalent spot diameter changes to S (S=0.5d+D). The power density of the formed spot does not decrease accordingly, while the equivalent diameter increases, which can adapt to flexible laser processing on various occasions.

The present disclosure first proposes a new method for changing the equivalent spot diameter, which can ensure that the power density basically does not decrease and can permit real-time changing of the spot diameter during laser processing, thereby realizing smart workpiece processing and achieving good processing effect. The special electromechanical module 7 is employed to cause ultrahigh frequency micro-oscillation between 0 and D (e.g., D is equal, but not limited, to 500 μm) of any one of the focusing lens 5, the collimating lens and the optical fiber end cap 14, with an oscillation frequency ranging from 1 kHz to 30 kHz. The system and method are applicable to laser processing occasions requiring a varying optical fiber core diameter, such as laser cutting, laser welding, and laser additive and subtractive manufacturing. The oscillation form of any one of the focusing lens 5, the collimating lens and the output optical fiber is that it revolves at an ultrahigh frequency around an axis parallel to its axis without spinning itself.

Specific embodiments are used herein to explain the principles and implementations of the present disclosure. The description of the foregoing examples is merely intended to help understand the method of the present disclosure and the core ideas thereof. Moreover, various modifications can be made by those of ordinary skill in the art to the specific implementations and the scope of application in accordance with the ideas of the present disclosure. In conclusion, the contents of this specification shall not be construed as limitations to the present disclosure.

What is claimed is:

1. A laser head capable of dynamically regulating a laser spot by high frequency/ultrahigh frequency micro-vibration, comprising: a laser transmitting device, a cavity, a special electromechanical module and a shielded nozzle, wherein the laser transmitting device is disposed at the top of the cavity to emit laser into the cavity through an entrance port formed in the top of the cavity; a first protective glass and a collimating lens are sequentially disposed from top to bottom within the cavity; the special electromechanical module is disposed at the bottom of the cavity and connected to the cavity by means of a housing; light holes are formed in the top and bottom of the housing of the special electromechanical module, respectively; a focusing lens is further disposed within the housing of the special electromechanical module, and a flat spring is disposed between the focusing lens and the special electromechanical module; the special electromechanical module is capable of causing ultrahigh frequency micro-oscillation of the focusing lens; and the shielded nozzle is disposed at the bottom of the special electromechanical module.

2. The laser head capable of dynamically regulating a laser spot by high frequency/ultrahigh frequency micro-vibration according to claim 1, wherein an optical fiber end cap is disposed between the laser transmitting device and the cavity.

3. The laser head capable of dynamically regulating a laser spot by high frequency/ultrahigh frequency micro-vibration according to claim 1, wherein the special electromechanical module is a voice coil motor; a lens holder for the focusing lens is connected to a live coil of the voice coil motor; the flat spring is connected to a housing of the voice coil motor; when a high-frequency alternating current is applied to the live coil, a magnetic field generated by the live coil interacts with a magnetic field of a permanent magnet to induce a high frequency periodic force for acting on the focusing lens, which is also simultaneously acted upon by the force of the flat spring; driven by the two forces, the focusing lens spins like a satellite at an ultrahigh frequency.

4. The laser head capable of dynamically regulating a laser spot by high frequency/ultrahigh frequency micro-vibration according to claim 1, wherein the special electromechanical module is a vibration exciter.

5. The laser head capable of dynamically regulating a laser spot by high frequency/ultrahigh frequency micro-vibration according to claim 1, wherein a second protective glass is further disposed at an internal bottom end of the housing of the special electromechanical module.

6. The laser head capable of dynamically regulating a laser spot by high frequency/ultrahigh frequency micro-vibration according to claim 1, wherein the entrance port, the first protective glass, the collimating lens, the light holes, the focusing lens and the second protective glass are disposed concentrically.

7. The laser head capable of dynamically regulating a laser spot by high frequency/ultrahigh frequency micro-vibration according to claim 1, wherein the light emitted by the laser transmitting device is a Gaussian beam having a wavelength ranging from 1030 to 1080 nm.

8. The laser head capable of dynamically regulating a laser spot by high frequency/ultrahigh frequency micro-vibration according to claim 1, wherein the collimating lens has a diameter greater than a cross-section size of the Gaussian beam at a position where the lens is located so as to encompass the entire beam within a refraction range.
